(19) United States
(12) Patent Application Publication
(10) Pub. No.: US 2026/0280308 A1
(43) Pub. Date: Sep. 17, 2026

(54) CHARGING DEVICE AND POWER TRANSMISSION METHOD

(71) Applicant: DELTA ELECTRONICS, INC., Taoyuan City (TW)

(72) Inventors: Han-Min LEE, Taoyuan City (TW); Hao-Jui LIU, Taoyuan City (TW); Chih-Chieh LIN, Taoyuan City (TW)

(21) Appl. No.: 19/461,688

(22) Filed: Jan. 27, 2026

Related U.S. Application Data
(60) Provisional application No. 63/771,593, filed on Mar. 13, 2025.

(30) Foreign Application Priority Data
Aug. 12, 2025 (TW) 114130787

(51) Int. Cl. H02J 7/34; B60L 53/16; B60L 53/30; B60L 53/57; B60L 55/00; B60L 58/20; H02J 7/44; H02J 7/96

(52) U.S. Cl. CPC H02J 7/342; B60L 53/16; B60L 53/305; B60L 53/57; B60L 55/00; B60L 58/20; H02J 7/44; H02J 7/96

(57) ABSTRACT

A charging device, comprising a first connector, a second connector and a control circuit. The first connector has a first detection resistor. When the first connector is connected to an electric vehicle through the first detection resistor, the first connector receives a first supply power. The second connector has a second detection resistor. The control circuit is electrically connected to the first connector and the second connector, and is configured to be driven by the first supply power. The control circuit is configured to utilize the first supply power to supply power to an external device according to a voltage across the second detection resistor, or transmit a communication signal to the electric vehicle according to the voltage across the second detection resistor to obtain a second supply power from the electric vehicle. The first supply power is different from the second supply power.

### CROSS - REFERENCE TO RELATED APPLICATION

This application claims priority to U.S. Provisional Application Serial Number 63/771,593 filed March 13, 2025, and Taiwan Application Serial Number 114130787, filed August 12, 2025, the disclosures of which are incorporated herein by reference in their entireties.

### BACKGROUND

### Technical Field

The present disclosure relates to power transmission technology, and more particularly to a charging device and a power transmission method.

### Description of Related Art

In recent years, with growing environmental awareness, the development of electric vehicles has received increasing attention. To promote widespread use of electric vehicles, "charging device" used by electric vehicles is quite crucial. Therefore, how to enhance the convenience, application flexibility, and usability of the charging device has become a major challenge.

### SUMMARY

One aspect of the present disclosure is a charging device, comprising a first connector, a second connector and a control circuit. The first connector has a first detection resistor. When the first connector is connected to an electric vehicle through the first detection resistor, the first connector receives a first supply power. The second connector has a second detection resistor. The control circuit is electrically connected to the first connector and the second connector, and is configured to be driven by the first supply power. The control circuit is configured to utilize the first supply power to supply power to an external device according to a voltage across the second detection resistor, or transmit a communication signal to the electric vehicle according to the voltage across the second detection resistor to obtain a second supply power from the electric vehicle. The first supply power is different from the second supply power.

Another aspect of the present disclosure is a power transmission method, comprising: receiving a first supply power from an electric vehicle when a charging device is connected to the electric vehicle through a first detection resistor; utilizing the first supply power to drive a control circuit of the charging device; determining, by the control circuit, a voltage across a second detection resistor of the charging device; and selectively utilizing the first supply power to supply power to an external device, or obtaining a second supply power from the electric vehicle, according to the voltage across a second detection resistor, wherein the first supply power is different from the second supply power.

Another aspect of the present disclosure is a charging device, comprising a first connector and a control circuit. The first connector has a first detection resistor. When the first connector is connected to an electric vehicle through the first detection resistor, the first connector receives a supply power from the electric vehicle. The control circuit is electrically connected to the first connector, and is configured to be driven by the supply power. When the charging device is connected to an external device and obtains a sensing signal, the control circuit is configured to utilize the supply power to supply power to the external device, and is configured to selectively provide a communication signal to the electric vehicle, so that the electric vehicle changes a voltage of the supply power.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of a charging device and an applied electric vehicle in some embodiments of the present disclosure.

FIG. 2 is a schematic diagram of the charging device in some embodiments of the present disclosure.

FIG. 3 is a flowchart illustrating a power transmission method in some embodiments of the present disclosure.

FIG. 4A is a schematic diagram of the operating state of the charging device in some embodiments of the present disclosure.

FIGS. 4B-4C are schematic diagrams of the operating states of the charging device in some embodiments of the present disclosure.

FIG. 5 is a signal waveform diagram of the charging device in some embodiments of the present disclosure.

### DETAILED DESCRIPTION

For the embodiment below is described in detail with the accompanying drawings, embodiments are not provided to limit the scope of the present disclosure. Moreover, the operation of the described structure is not for limiting the order of implementation. Any device with equivalent functions that is produced from a structure formed by a recombination of elements is all covered by the scope of the present disclosure. Drawings are for the purpose of illustration only, and not plotted in accordance with the original size.

It will be understood that when an element is referred to as being "connected to" or "coupled to", it can be directly connected or coupled to the other element or intervening elements may be present. In contrast, when an element to another element is referred to as being "directly connected" or "directly coupled," there are no intervening elements present. As used herein, the term "and/or" includes associated listed items or any and all combinations of more.

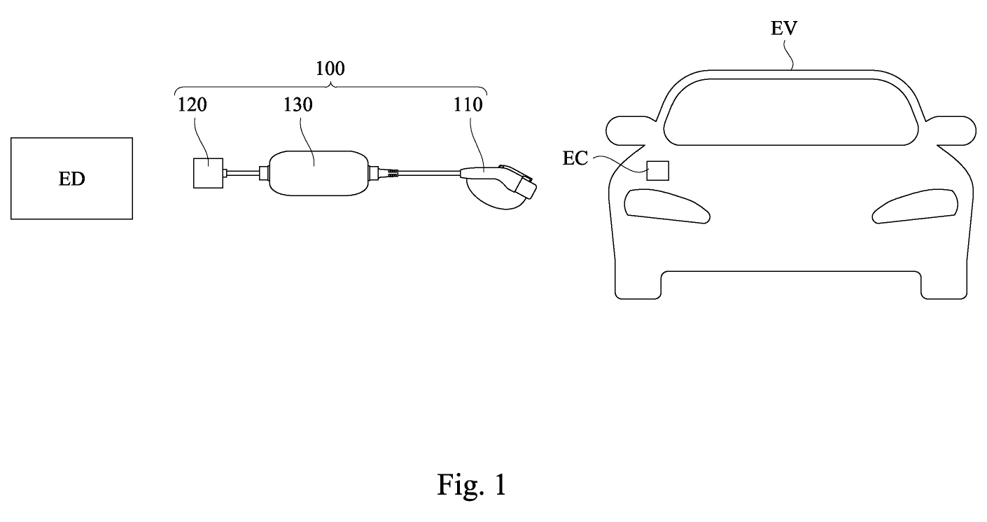

The present disclosure relates to a charging device and a power transmission method. FIG. 1 is a schematic diagram of a charging device 100 and an applied electric vehicle EV in some embodiments of the present disclosure. In this embodiment, the charging device 100 is configured to connect the electric vehicle EV and another external device ED, so as to perform unidirectional or bidirectional power transmission. For example, the electric vehicle EV can supply power to the external device ED through the charging device 100, or the external device ED can charge the electric vehicle EV through the charging device 100.

The external device can be another electric vehicle, a charging station, a storage battery of the electric vehicle or any electric appliance, such as a computer, a smart phone, a network router, a fan, a lamp.

In this embodiment, the charging device 100 includes a first connector 110, a second connector 120 and a control circuit 130. The connection interface of the first connector 110 is matched with the connection interface of the connection port EC of the electric vehicle EV, so as to couple to the connection port EC. The connection interface of the second connector 120 is matched with the connection interface of the external device ED (or its charger), so as to couple to the external device ED. In one embodiment, the second connector 120 has one or more AC sockets, such as Type A, Type B or Type C sockets, but the present disclosure is not limited thereto.

The control circuit 130 is electrically connected between the first connector 110 and the second connector 120, so as to obtain the supply power from one of the electric vehicle EV or the external device ED, and provide the supply power to another of the electric vehicle EV or the external device ED. It shall be noted that, although FIG. 1 illustrates the charging device 100 as a device assembled by three components "the first connector 110, the second connector 120 and the control circuit 130", the present disclosure is not limited thereto. In other embodiments, the first connector 110, the second connector 120 and the control circuit 130 may be integrated into the same component.

Through designing the connection interface of the first connector 110 and the second connector 120 to correspond to the electric vehicle EV and the external device ED, a path of power transmission may be implemented in "hardware configuration". However, the "control mechanism" still need a corresponding supporting measures, because the operating voltages of the electric vehicle EV and the external device ED are not necessarily the same. For example, the charging and discharging voltage used by the electric vehicle EV is 240V, but the applied voltage of the AC socket may be 100-120V. Therefore, if the charging device 100 is to be applied to different charging application, the charging device 100 must have a control mechanism, so as to obtain the required supply power.

In the following embodiments, the two application methods of V2V (Vehicle-to-Vehicle) and V2L (Vehicle-to-Load) are taken as examples for description. V2V refers to an application of charging one electric vehicle by another electric vehicle, wherein the operating voltage is 240V. V2L is an application of charging electric appliances by using the electric energy of the electric vehicle, wherein the operating voltage is 120V.

In order to enable the charging device 100 to obtain power with a corresponding voltage from a "power supply device (e.g., the electric vehicle EV)" according to the need of a "device under charge (e.g., the external device ED)", one method is to enable the charging device 100 to detect the specification of the external device ED, and then transmit a communication signal to the electric vehicle EV, so that the electric vehicle EV will change the output voltage. However, to implement this method, the charging device 100 must configure a battery internally to execute functions such as detection and communication, and the battery will affect the cost and volume of the charging device 100.

Another method is to configure a specific detection resistor in the charging device 100. When the electric vehicle EV is connected to the charging device 100, the electric vehicle EV can confirm the voltage required by the charging device 100 by identifying the impedance value of the detection resistor (e.g., determining the voltage across). However, the detection resistor can only correspond to a single specification, and cannot be automatically switched between different application.

The charging device and the power transmission method provided by the present disclosure are able to obtain a sensing signal from the second connector, and then obtain a supply power with a corresponding voltage from the electric vehicle. In addition, in some embodiments, the charging device may be configured to operate without a battery, and is configured to be driven by the supply power provided by the electric vehicle.

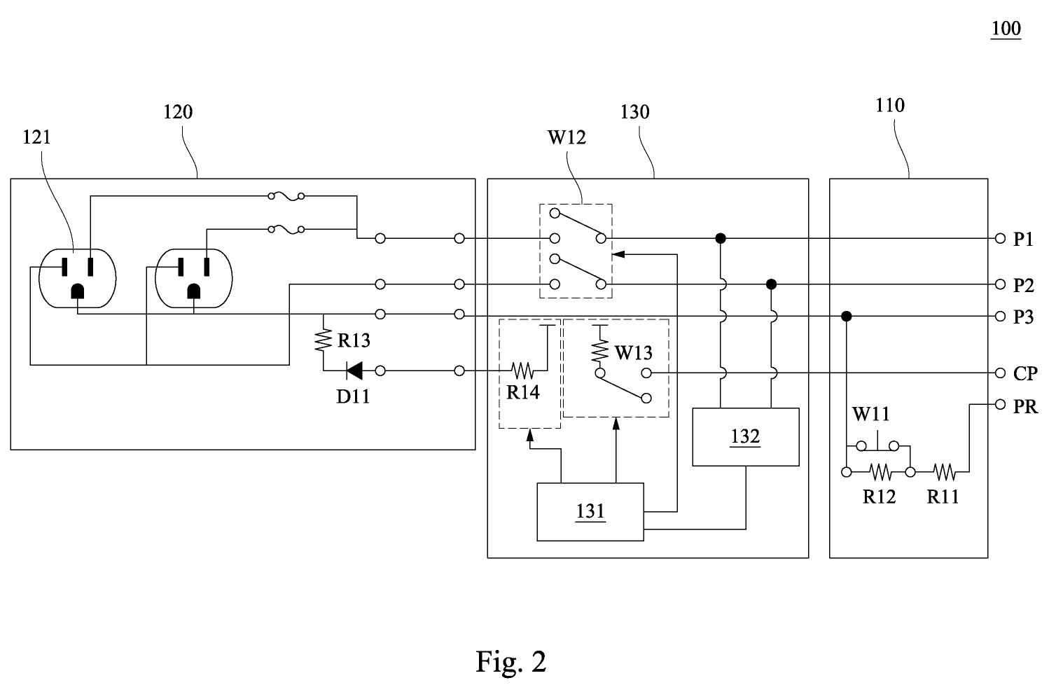

FIG. 2 is a schematic diagram of the internal circuit of the charging device 100 in some embodiments of the present disclosure. The first connector 110 includes a plurality of terminals, which can be divided into "power terminal" for transmitting power, and "signal terminal" for transmitting data, according to the difference in transmission content. In this embodiment, "the power terminal" includes power-supply terminals P1-P2 for transmitting alternating current, and a grounding terminal P3. "The signal terminal" includes an identification terminal PR and a communication terminal CP, which is configured to transmit the control signal and the communication signal, such as determining whether the connector is correctly connected, transmitting a specific voltage to indicate a specific charging mode.

The terminal configuration shown in FIG. 2 is only one embodiment of the present disclosure, and the present disclosure is not limited thereto. In other embodiments, the connector may be a different charging specification/interface, and may have a different terminal configuration. In other words, the connector has at least one power-supply terminal and at least one signal terminal, and the number and configuration positions of the terminals can be adjusted according to the actual application specification.

The first connector 110 further includes a detection resistor R11. The detection resistor R11 is coupled to the identification terminal PR. When the charging device 100 is connected to the electric vehicle EV, the electric vehicle EV can determine the impedance value of the detection resistor R11, so as to confirm the power required by the charging device 100. Since one of ordinary skill in the art can understand the method and principle of the electric vehicle EV determining the impedance value of the detection resistor R11, it will not be further described herein.

In one embodiment, the impedance value of the detection resistor R11 corresponds to V2V, therefore the electric vehicle EV will provide the supply power of 240V voltage (hereinafter referred to as “first supply power”) according to the detection resistor R11.

In one embodiment, as shown in FIG. 2, the first connector 110 further includes a resistor R12 and a switch W11 connected in parallel with each other. The resistor R12 and the switch W11 are coupled to the detection resistor R11, wherein the switch W11 is a fool-proof switch. User must press a button on the charging device 100 to open the switch W11, so as to enable the charging device 100 to connect to the electric vehicle EV. Then, the user needs to release the button to short-circuit the switch W11, so as to enable the electric vehicle EV to identify the detection resistor R11. In some embodiments, the resistor R12 may also be used as the detection resistor.

The second connector 120 is configured to be electrically connected to the external device ED, and includes a detection resistor R13 and at least one AC connection port 121. The AC connection port 121 is coupled to the detection resistor R13, and the detection resistor R13 is further coupled to a grounding node or the grounding terminal P3 in the second connector 120. In one embodiment, the second connector 120 further includes a unidirectional switch D11, wherein the unidirectional switch D11 is configured to prevent current from being transmitted reversely through the detection resistor R13. In addition, the detection resistor R13 and the unidirectional switch D11 may be further coupled to a resistor R14 in the control circuit 130, so as to adaptively adjust the voltage across the second detection resistor according to the specification of the controller 131 in the control circuit 130.

The control circuit 130 is coupled between the first connector 110 and the second connector 120, and belongs to a different component from the second connector 120 which can be assembled and disassembled. In other words, the control circuit 130 and the second connector 120 can be respectively packaged in different device housings, and can be connected to each other through a connection port or a connector. When the control circuit 130 is connected to the second connector 120, the control circuit 130 can obtain the sensing signal from the second connector 120, so as to determine whether the communication signal needs to be generated to the electric vehicle EV.

As mentioned above, specifically, the sensing signal may be a voltage of a specific node in the second connector 120, or a voltage across a specific component. As shown in FIG. 2, when the control circuit 130 is coupled to the second connector 120, the control circuit 130 is configured to determine the voltage across the detection resistor R13. The control circuit 130 can confirm the type of the second connector 120 (i.e., applied to V2V or V2L), and confirm the required charging voltage according to the voltage across the detection resistor R13. In other embodiments, "the sensing signal" may also be a handshake signal provided by the second connector 120 or the external device ED.

In this embodiment, the control circuit 130 does not need to configure a battery internally. When the first connector 110 is connected to the electric vehicle EV, the electric vehicle EV will provide the first supply power, and the control circuit 130 will be driven according to the first supply power, so as to detect the voltage across the detection resistor R13. After detecting the voltage across the detection resistor R13, if it is determined that the voltage required by the second connector 120 is different from the first supply power, the control circuit 130 will transmit the communication signal to the electric vehicle EV through the communication terminal CP, so that the electric vehicle EV will change the voltage of the supply power. Here, the supply power corresponding to the detection resistor R13 is referred to as "second supply power", and the voltage of the second supply power is different from the voltage of the first supply power.

On the other hand, If it is determined that the voltage required by the second connector 120 is the same as the first supply power, then the control circuit 130 will not need to transmit the communication signal, and can directly utilize the first supply power to supply power to the external device ED.

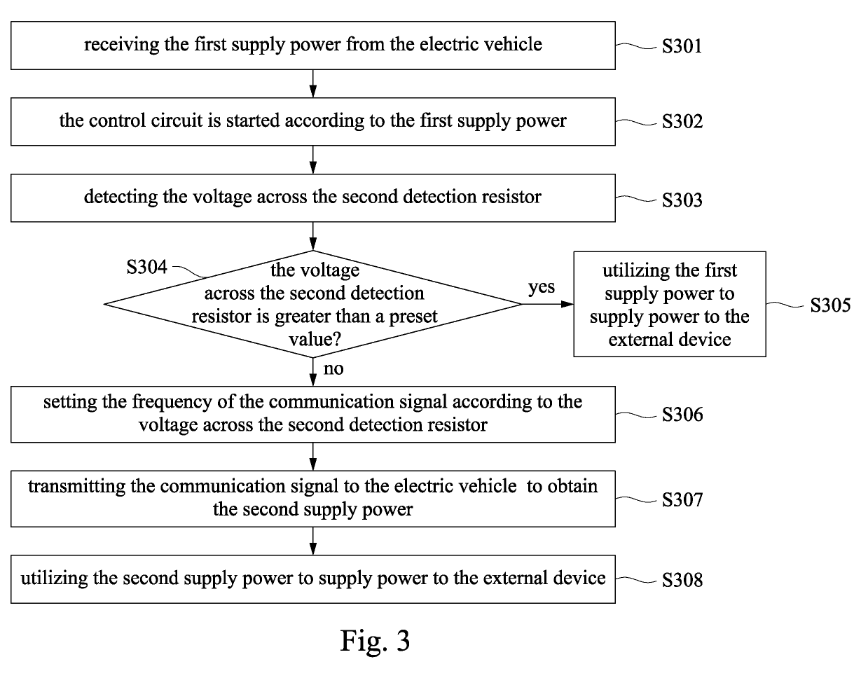

In order to facilitate the understanding of the operation of the charging device 100, the power transmission method used by the charging device 100 is described here. Taking the flowchart shown in FIG. 3 as an example, referring to FIG. 1 to FIG. 3, in step S301, when a user wants to supply power to the external device ED by utilizing the power of the electric vehicle EV by the charging device 100, the user first connects the first connector 110 to the electric vehicle EV, and connects the second connector 120 to the external device ED. At this time, the electric vehicle EV will confirm the first supply power required by the charging device 100 (e.g., 240V of V2V application) through the detection resistor R11 (the first detection resistor). Therefore, the charging device 100 receives the first supply power from the electric vehicle EV.

In this embodiment, the control circuit 130 further includes a controller 131, at least one power-supply switch W12 and a conversion circuit 132. The controller 131 is configured to perform various steps of the control circuit 130 in the flowchart shown in FIG. 3. The power-supply switch W12 is a normally open switch, and is coupled between at least one power-supply terminal and the second connector 120. The conversion circuit 132 may be an AC-DC conversion circuit, which is coupled to at least one power-supply terminal P1 or P2, and is coupled to the controller 131. In other words, the power-supply terminals P1, P2 will be respectively coupled to the conversion circuit 132 and the power-supply switch W12, and are configured to supply power to the controller 131 of the control circuit 130.

In step S302, when the controller 131 of the control circuit 130 receives the first supply power through the conversion circuit 132 and the power-supply terminals P1, P2, the controller 131 will be started/driven according to the first supply power. Since the power-supply switch W12 is in a shutdown (open circuit) state, the control circuit 130 will not provide the first supply power to the second connector 120 yet.

In step S303, after the control circuit 130 is started by utilizing the first supply power, the controller 131 will actively detect the voltage across the detection resistor R13 (the second detection resistor) in the second connector 120, so as to be used as the sensing signal. The voltage across the detection resistor R13 will reflect the type of the second connector 120 (or the type corresponding to the external device ED), so that the controller 131 can confirm the charging voltage required by the second connector 120/the external device ED. In one embodiment, the controller 131 stores a specification data, so as to be able to confirm the charging voltage required by the second connector 120/the external device ED according to the voltage across the detection resistor R13 by looking up a table.

In step S304, the controller 131 determines whether the voltage across the detection resistor R13 (the second detection resistor) is equal to or greater than a preset value. The preset value may be a threshold value stored in the controller 131, such as 12V. In one embodiment, if the voltage across the detection resistor R13 is equal to or greater than the preset value, it represents that the current charging application is "V2V", that is, the charging voltage required by the second connector 120/the external device ED is 240V. If the voltage across the detection resistor R13 is less than the preset value, it represents that the current charging application is "V2L", that is, the charging voltage required by the second connector 120/the external device ED is 120V.

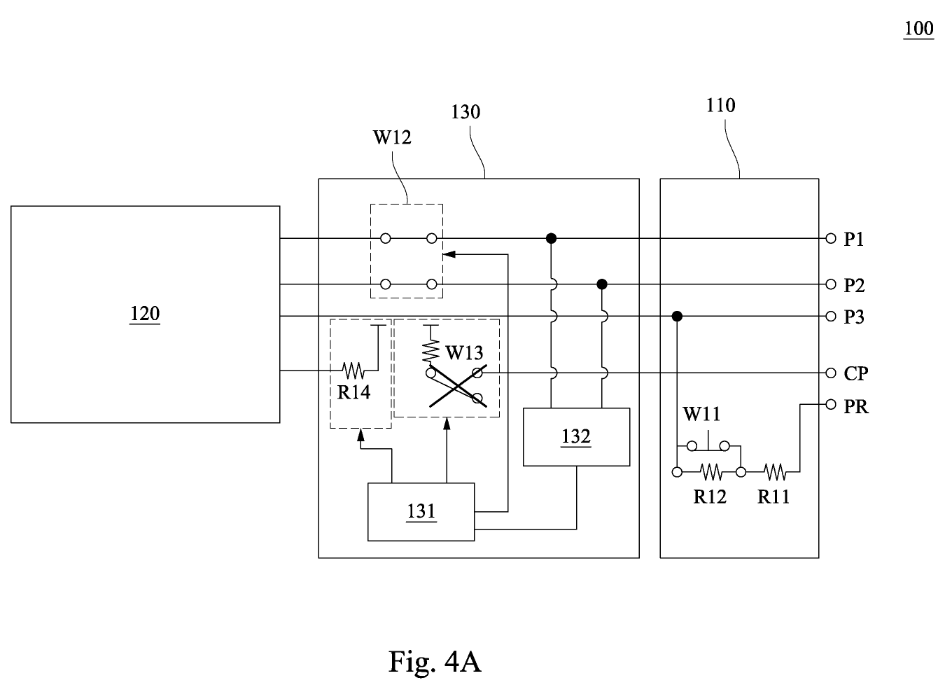

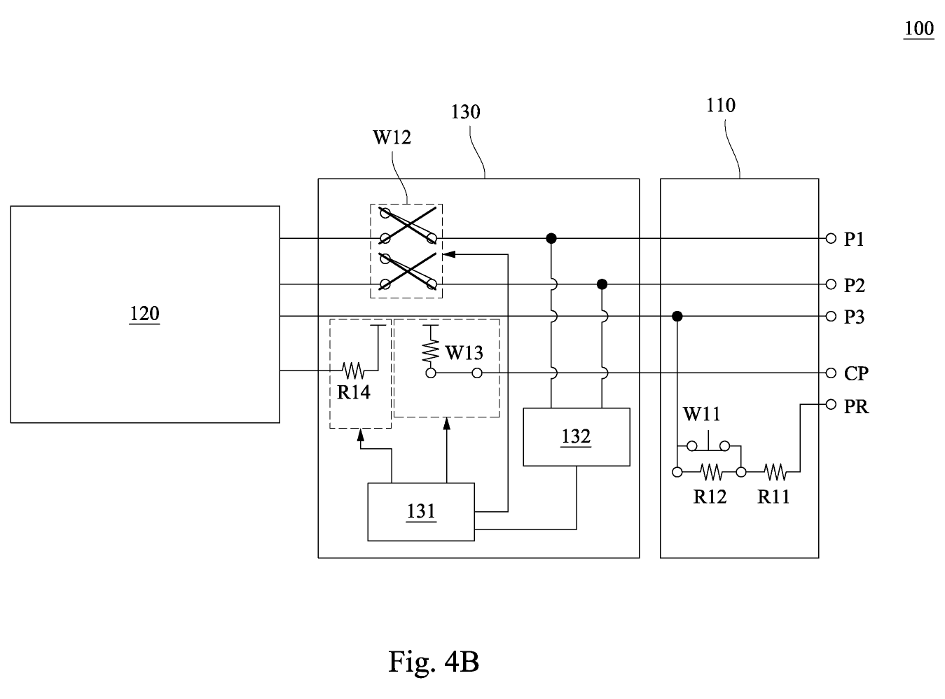

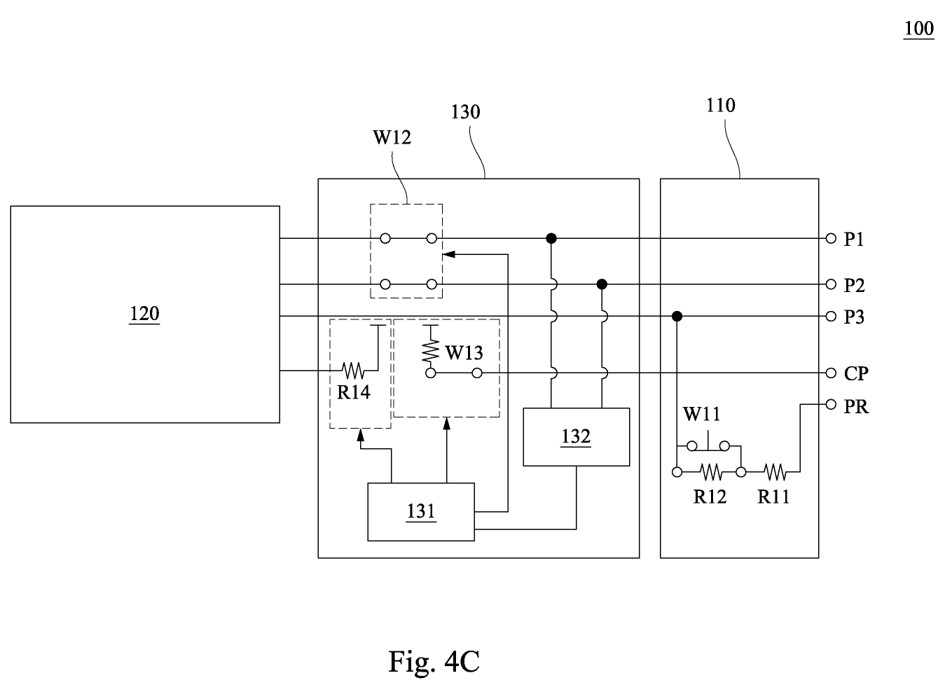

In step S305, if it is determined that the voltage across the detection resistor R13 (the second detection resistor) is equal to or greater than the preset value, it represents that the charging application is "V2V". At this time, the control circuit 130 will utilize the first supply power to supply power to the external device ED. FIG. 4A illustrates an operating state diagram of the charging device 100 during "V2V" application. Since the "V2V" specification of the second connector 120 is different from the "V2L" specification, it is simply drawn as a circuit block. In this embodiment, the control circuit 130 turns on the power-supply switch W12, so as to enable the first supply power to be transmitted to the external device ED through the power-supply terminals P1-P2 and the second connector 120. At this time, the charging device 100 does not need to use the communication terminal CP to handshake with the electric vehicle EV.

In some embodiments, the controller 131 may further turn on the power-supply switch W12 after determining that the voltage of the power-supply terminal P1 and/or the power-supply terminal P2 is stable (e.g., the voltage change does not exceed a preset range within a period of time), so as to utilize the first supply power to supply power to the external device ED.

In step S306, if it is determined that the voltage across the detection resistor R13 (the second detection resistor) (e.g., 3V) is less than the preset value, it represents that the charging application is "V2L". At this time, the controller 131 will generate the communication signal, and the controller 131 generates/sets the frequency of the communication signal according to the voltage across the detection resistor R13. This frequency will correspond to the charging voltage required by the second connector 120/the external device ED.

In one embodiment, the communication signal is a type of handshake signal, which is configured to enable the electric vehicle EV to confirm the voltage required by the charging device 100. In one embodiment, the communication signal is a pulse width modulation signal, and the control circuit 130 can set the frequency and/or duty cycle of the pulse width modulation signal.

In step S307, after determining the frequency of the communication signal, the controller 131 will transmit the communication signal to the electric vehicle EV through the communication terminal CP, so as to obtain the second supply power (i.e., make the electric vehicle to change the voltage of the supply power), such as 120V.

In one embodiment, the control circuit 130 includes a communication switch W13. The communication switch W13 is coupled to the communication terminal CP of the first connector 110, and is a normally open switch. In other words, before the first connector 110 is coupled to the electric vehicle EV, the communication switch W13 remains turned off (e.g., shut down or open circuit). Similarly, when the control circuit 130 does not actively control to turn on the communication switch W13, the communication switch W13 also remains turned off. After the control circuit 130 is driven by utilizing the first supply power, if the control circuit 130 confirms that the charging application is "V2L", the control circuit 130 will turn on the communication switch W13, so as to transmit the communication signal to the electric vehicle EV through the communication terminal CP.

FIG. 4B to FIG. 4C illustrate operating state diagrams of the charging device 100 during "V2V" application. The details of the aforementioned steps S304, S306 and S307 are described hereinafter with reference to FIG. 4B to FIG. 4C. In this embodiment, the specification of the second connector 120 corresponds to "V2L". Therefore, as shown in FIG. 4B, when the control circuit 130 determines that the voltage across the detection resistor R13 is less than the preset value, the control circuit 130 will turn on the communication switch W13, so as to transmit the communication signal to the electric vehicle EV, so that the electric vehicle EV adjusts/changes the voltage of the output power.

Next, as shown in FIG. 4C, in step S308, after the electric vehicle EV provides the second supply power, the control circuit 130 will utilize the second supply power to supply power to the external device ED. Specifically, the control circuit 130 first determines whether the voltage of the power-supply terminals P1, P2 is stable. After confirming that the voltage of the power-supply terminals P1, P2 is stable, the control circuit 130 turns on the power-supply switch W12, so as to utilize the second supply power to supply power to the external device ED. Accordingly, in different charging applications, the charging device 100 will be able to automatically obtain the supply power with different voltages from the electric vehicle EV, so as to supply power to various types of the second connector 120/the external device ED.

In addition, in some embodiments, the charging device 100 has two operation. The first operation is to start the control circuit 130 to supply power to the external device ED according to the first supply power. At this time, the charging device 100 does not need to handshake with the electric vehicle EV through the communication terminal CP. The second operation is to transmit the communication signal to the electric vehicle EV through the communication terminal CP, so as to obtain the second supply power. As shown in FIG. 2, the charging device 100 can start/drive the control circuit 130 by utilizing the first supply power or the second supply power through the power-supply terminals P1, P2, therefore the charging device 100 may not configure an internal battery.

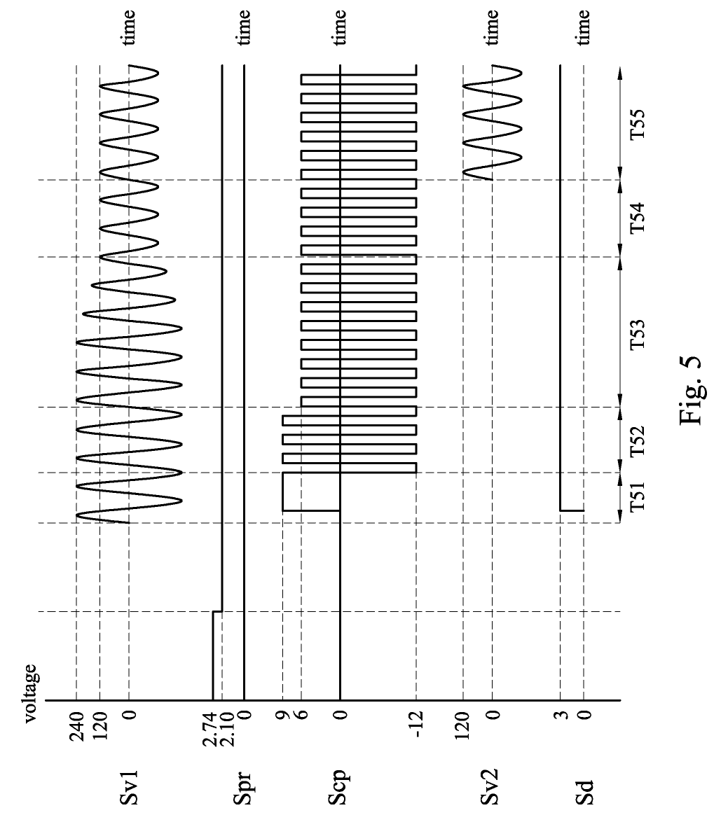

FIG. 5 is a signal waveform diagram of the charging device in some embodiments of the present disclosure, wherein the supply power Sv1 provided by the electric vehicle EV, the cross-voltage signal Spr of the detection resistor R11, the communication signal Scp, the output power Sv2 output by the charging device 100 and the sensing signal Sd obtained by the controller 131 are illustrated.

Referring to FIG. 1, FIG. 2 and FIG. 5, during the time period T51, the charging device 100 is connected to the electric vehicle EV, and the electric vehicle EV provides the supply power Sv1 (the first supply power) according to the detection resistor R11 (or with the resistor R12). At this time, the power-supply switch W12 in the charging device 100 is in a shutdown state, therefore the supply power Sv1 is not transmitted to the second connector 120, and the output power Sv2 is zero.

As mentioned above, during the time period T51, the controller 131 will determine the voltage across the detection resistor R13, so as to obtain the sensing signal Sd. In this embodiment, the controller 131 will confirm that the current application is "V2L" according to the voltage across the detection resistor R13. Therefore, during the time period T52, the controller 131 will generate the communication signal Scp.

During the time period T52, the controller 131 turns on the communication switch W13, so as to transmit the communication signal Scp to the electric vehicle EV through the communication terminal CP of the first connector 110. Therefore, the electric vehicle EV will adjust/change the voltage of the supply power Sv1 according to the frequency of the communication signal Scp. The voltage of the communication signal Scp will change during the time period T52-T53. In some embodiments, the controller 131 may first transmit a handshake signal during the time period T52, and then provide the communication signal Scp during the time period T53, so as to make the electric vehicle EV to adjust/change the voltage of the output power. The transmission timing of the communication signal Scp is not limited to the waveform shown in FIG. 5, and the voltage magnitude (amplitude) of the communication signal Scp may change according to the type of the electric vehicle EV.

During the time period T54, the controller 131 determines that the voltage of the supply power Sv1 is changed to 120V (the second supply power). At this time, the controller 131 may further determine whether the supply power Sv1 is stable. During the time period T55, the controller 131 turns on the power-supply switch W12 after confirming that the supply power Sv1 is stable, so as to generate the output power Sv2 according to the supply power Sv1, to supply power to the external device ED.

As mentioned above, in one embodiment, the first connector 110, the second connector 120 and the control circuit 130 may be three different components, and may be assembled as one body. Therefore, the control circuit 130 may be used with the first connector 110 or the second connector 120 having different the connection interface, so as to match different charging application. In other embodiments, the first connector 110, the second connector 120 and the control circuit 130 may also be packaged/integrated into a single device, so as to make the volume more compact.

The elements, method steps, or technical features in the foregoing embodiments may be combined with each other, and are not limited to the order of the specification description or the order of the drawings in the present disclosure.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

What is claimed is:

1. A charging device, comprising:
a first connector having a first detection resistor, wherein when the first connector is connected to an electric vehicle through the first detection resistor, the first connector receives a first supply power;
a second connector having a second detection resistor; and
a control circuit is electrically connected to the first connector and the second connector, and configured to be driven by the first supply power;
wherein the control circuit is configured to utilize the first supply power to supply power to an external device according to a voltage across the second detection resistor, or transmit a communication signal to the electric vehicle according to the voltage across the second detection resistor to obtain a second supply power from the electric vehicle;
wherein the first supply power is different from the second supply power.

2. The charging device of claim 1, wherein the communication signal is a pulse width modulation signal, and the control circuit is configured to set a frequency of the communication signal according to the voltage across the second detection resistor.

3. The charging device of claim 1, wherein when the voltage across the second detection resistor is greater than a preset value, the control circuit utilizes the first supply power to supply power to the external device.

4. The charging device of claim 1, wherein when the voltage across the second detection resistor is less than a preset value, the control circuit generates the communication signal.

5. The charging device of claim 1, wherein the first connector comprises:
an identification terminal coupled to the first detection resistor;
a communication terminal coupled to a communication switch of the control circuit, and configured to transmit the communication signal; and
at least one power-supply terminal configured to transmit the first supply power or the second supply power.

6. The charging device of claim 5, wherein after the control circuit is driven by the first supply power, the control circuit is configured to turn on the communication switch to transmit the communication signal.

7. The charging device of claim 5, wherein the control circuit comprises a power-supply switch coupled to the at least one power-supply terminal, after determining that a voltage of the at least one power-supply terminal is stable, the control circuit turns on the power-supply switch to supply power to the external device.

8. The charging device of claim 7, wherein the at least one power-supply terminal is respectively connected to the power-supply switch and a controller of the control circuit, and is configured to transmit the first supply power or the second supply power to the controller.

9. A power transmission method, comprising:
receiving a first supply power from an electric vehicle when a charging device is connected to the electric vehicle through a first detection resistor;
utilizing the first supply power to drive a control circuit of the charging device;
determining, by the control circuit, a voltage across a second detection resistor of the charging device; and
selectively utilizing the first supply power to supply power to an external device, or obtaining a second supply power from the electric vehicle, according to the voltage across a second detection resistor, wherein the first supply power is different from the second supply power.

10. The power transmission method of claim 9, wherein selectively utilizing the first supply power to supply power to the external device, or obtaining the second supply power from the electric vehicle comprises:
when the voltage across the second detection resistor is greater than a preset value, utilizeing the first supply power to supply power to the external device.

11. The power transmission method of claim 9, wherein selectively utilizing the first supply power to supply power to the external device, or obtaining the second supply power from the electric vehicle comprises:
when the voltage across the second detection resistor is less than a preset value, generating a communication signal to obtaine the second supply power from the electric vehicle.

12. The power transmission method of claim 11, wherein the communication signal is a pulse width modulation signal, and generating the communication signal to obtaine the second supply power from the electric vehicle comprises:
setting a frequency of the communication signal according to the voltage across the second detection resistor.

13. The power transmission method of claim 11, further comprising:
when determining the voltage across the second detection resistor is less than the preset value, turning on a communication switch of the control circuit, wherein the control circuit transmits the communication signal to the electric vehicle through a communication terminal coupled to the communication switch.

14. The power transmission method of claim 9, wherein the charging device receive the first supply power and the second supply power through at least one power-supply terminal, and the power transmission method further comprises:
after determining that a voltage of the at least one power-supply terminal is stable, turning on a power-supply switch of the control circuit, so as to utilize the first supply power or the second supply power provided by the electric vehicle to supply power to the external device.

15. A charging device, comprising:
a first connector having a first detection resistor, wherein when the first connector is connected to an electric vehicle through the first detection resistor, the first connector receives a supply power from the electric vehicle; and
a control circuit is electrically connected to the first connector, and configured to be driven by the supply power;
wherein when the charging device is connected to an external device and obtains a sensing signal, the control circuit is configured to utilize the supply power to supply power to the external device, and is configured to selectively provide a communication signal to the electric vehicle, so that the electric vehicle changes a voltage of the supply power.

16. The charging device of claim 15, further comprising:
a second connector electrically connected to the control circuit, and electrically connected to the external device through a second detection resistor, wherein the control circuit is configured to obtain a voltage across the second detection resistor as the sensing signal, so as to set a frequency of the communication signal.

17. The charging device of claim 16, wherein the first connector comprises:
an identification terminal coupled to the first detection resistor;
a communication terminal coupled to a communication switch of the control circuit, and configured to transmit the communication signal; and
at least one power-supply terminal configured to transmit the supply power.

18. The charging device of claim 17, wherein when the voltage across the second detection resistor is greater than a preset value, the control circuit turns off the communication switch, so as to utilize the supply power to supply power to the external device.

19. The charging device of claim 17, wherein when the voltage across the second detection resistor is less than a preset value, the control circuit turns on the communication switch, so as to transmit the the communication signal to the electric vehicle.

20. The charging device of claim 17, wherein before the first connector is connected to the electric vehicle, the communication switch remains turned off.
